(19) United States
(12) Patent Application Publication
(10) Pub. No.: US 2026/0214466 A1
(43) Pub. Date: Jul. 23, 2026

(54) COMMUNICATION SYSTEMS, APPARATUSES, METHODS, AND NON-TRANSITORY COMPUTER-READABLE STORAGE MEDIA USING DENOISING DIFFUSION MODELS

(71) Applicant: HUAWEI TECHNOLOGIES CO., LTD., Shenzhen (CN)

(72) Inventors: Peyman Neshaastegaran, Ottawa (CA); Ming Jian, Kanata (CA)

(21) Appl. No.: 19/033,701

(22) Filed: Jan. 22, 2025

(51) Int. Cl. H04W 24/02; H04L 41/16

(52) U.S. Cl. CPC H04W 24/02; H04L 41/16

(57) ABSTRACT

A method has the steps of: passing a communication signal to a first artificial intelligence (AI) model to obtain a first signal; obtaining a plurality of second signals in accordance with a normal distribution; determining a denoised signal; and outputting the denoised signal; wherein said determining the denoised signal comprises: iteratively performing following actions for a plurality of time-steps: passing a current time-step selected from the plurality of time-steps to a second AI model to obtain a third signal, passing the first signal, a selected second signal selected in the current time-step from the plurality of second signals, and the third signal to a third AI model to obtain a predicted signal, and updating the second signal based on the predicted signal.

### FIELD OF THE DISCLOSURE

The present disclosure relates generally to communication systems, apparatuses, methods, and non-transitory computer-readable storage devices or media, and in particular to communication systems, apparatuses, methods, and non-transitory computer-readable storage devices or media using denoising diffusion models.

### BACKGROUND

Communication systems such as wireless communication systems are known. Generally, in a communication system, a transmitter (Tx) transmits one or more symbols as a communication signal through communication medium such as a free space, air, a cable, a wire, or the like. A receiver (Rx) receives the communication signal and retrieves the transmitted symbols. The received signal may be distorted by the communication medium or channel, and mixed with various noises (such as white noise, non-Gaussian noise, inter-channel interferences, and/or the like). Therefore, in some communication systems, the Tx and/or Rx may need to estimate and compensate for the channel effect, suppress the noises to improve the signal-to-noise (SNR) ratio (or the signal-to-interference-and-noise ratio (SINR)) so as to detect the transmitted symbols with low error probability. Numerous methods have been used for minimizing the error probability at the Rx.

### SUMMARY

According to one aspect of this disclosure, there is provided a method comprising: passing a communication signal to a first artificial intelligence (AI) model to obtain a first signal; obtaining a plurality of second signals in accordance with a normal distribution; determining a denoised signal; and outputting the denoised signal; wherein said determining the denoised signal comprises: iteratively performing following actions for a plurality of time-steps: passing a current time-step selected from the plurality of time-steps to a second AI model to obtain a third signal, passing the first signal, a selected second signal selected in the current time-step from the plurality of second signals, and the third signal to a third AI model to obtain a predicted signal, and updating the second signal based on the predicted signal.

In some implementations, said passing the communication signal to the first AI model to obtain the first signal comprises: transforming the communication signal into a preprocessed signal of a predefined or preconfigured size for matching a dimension requirement of the first AI model; and passing the communication signal to the first AI model to obtain the first signal.

In some implementations, the first AI model comprises: a sequence of convolutional layers; and one or more pairs of functions, each pair of functions being between a neighboring pair of convolutional layers, and comprising a layer normalization (LN) function and a rectified linear unit (ReLU) activation function.

In some implementations, each convolutional layer comprises a two-dimensional (2D) convolutional layer.

In some implementations, the third AI model comprises a U-Net model.

In some implementations, the plurality of time-steps comprise an ordered sequence of S time-steps τ_{S}, τ_{S-1}, . . . , τ₁ with τ₁<τ₂< . . . <τ_{S}; wherein the second signal is updated as:

$${x}_{{τ}_{i - 1}} = \sqrt{{\overline{α}}_{{τ}_{i - 1}}} ( \frac{{x}_{{τ}_{i}} - \sqrt{1 - {\overline{α}}_{{τ}_{i}}} {ϵ}_{θ} ( {x}_{{τ}_{i}} , {x}_{p} , {τ}_{i} )}{\sqrt{{\overline{α}}_{{τ}_{i}}}} ) + \sqrt{1 - {\overline{α}}_{{τ}_{i - 1}} - {η}_{{τ}_{i}}^{2}} {ϵ}_{θ} ( {x}_{{τ}_{i}} , {x}_{p} , {τ}_{i} ) + {η}_{{τ}_{i}} ψ .$$

where τᵢ is the current time-step, τᵢ₋₁ is a next time-step, x_{τ}_{ᵢ} is the second signal in the current time-step τᵢ, x_{τ}_{_{i−1}} is the second signal in the next time-step τᵢ₋₁, xₚ is the communication signal, ∈_{θ}(x_{τ}_{ᵢ}, xₚ, τᵢ) is the predicted signal,

$${\overline{α}}_{{τ}_{i}} = {\prod }_{k = 1}^{{τ}_{i}} {α}_{k} = {\prod }_{k = 1}^{{τ}_{i}} ( 1 - {β}_{k} ) , {β}_{k} ∈ ( 0 , 1 )$$

is a noise variance schedule at the time-step k, 0≤η_{τ}_{ᵢ}≤1 is a stochasticity parameter, and where ψ is obtained in accordance with a normal distribution if the current time-step is not τ₁, or is zero if the current time-step is τ₁.

In some implementations, the method further comprises: iteratively performing following actions for training the third AI model until predicted signal converges to a random signal: obtaining a training time-step by sampling from a set of training time-steps of 1, 2, . . . , T in accordance with a uniform distribution, obtaining a training input signal and a desired output signal from a training dataset, obtaining the random signal based on a normal distribution, passing the training input signal to the first AI model to obtain the first signal, passing the training time-step to the second AI model to obtain the third signal, calculating the second signal based on the random signal and the desired output signal, passing the first signal, the second signal, and the third signal to the third AI model to obtain the predicted signal, and updating the third AI model based on the random signal and the predicted signal.

In some implementations, the set of time-steps comprise S time-steps and is a subset of the set of training time-steps of 1, 2, . . . , T, where S<<T.

In some implementations, the second signal is calculated as:

$${x}_{t} = \sqrt{{\overline{α}}_{t}} {x}_{0} + \sqrt{1 - {\overline{α}}_{t}} ϵ ,$$

where t is the training time-step, xₜ is the second signal, x₀ is the desired output signal, ∈ is the random signal,

$${\overline{α}}_{t} = {\prod }_{k = 1}^{t} {α}_{k} = {\prod }_{k = 1}^{t} ( 1 - {β}_{k} ) ,$$

and βₖ ∈(0, 1) is a noise variance schedule at the time-step k; and said updating the third AI model based on the random signal and the predicted signal comprises: updating the third AI model based on a gradient descent step obtained from:

$${∇}_{θ} [ {‖ {ϵ}_{θ} ( {x}_{t} , {x}_{p} , t ) - ϵ ‖}^{2} ] .$$

According to one aspect of this disclosure, there is provided module comprising: one or more circuits such as one or more processors; and one or more memories storing instructions; wherein the instructions, when executed, cause the module to perform the above-described method.

According to one aspect of this disclosure, there is provided one or more non-transitory, computer-readable storage media comprising computer-executable instructions, wherein the instructions, when executed, cause one or more processors to perform the above-described method.

According to one aspect of this disclosure, there is provided one or more circuits such as one or more processors for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus, and configured to perform the any one of above mentioned methods and their implementations. Specifically, the apparatus includes one or more units configured to perform the any one of above mentioned methods and their implementations.

According to one aspect of this disclosure, there is provided a computer-readable storage medium. The computer-readable storage medium stores a computer program, and when the computer program is executed by an apparatus, the apparatus is enabled to implement the any one of above mentioned methods and their implementations.

According to one aspect of this disclosure, there is provided a computer program product including one or more instructions. When the instructions are executed by an apparatus such as a computer, the apparatus is enabled to implement the any one of above mentioned methods and their implementations.

According to one aspect of this disclosure, there is provided a computer program. When the computer program is executed by a computer, an apparatus is enabled to implement the any one of above mentioned methods and their implementations.

According to one aspect of this disclosure, there is provided a communication system. The communication system includes a first communication-node and/or a second communication-node, the first communication-node is configured to perform the method regarding with the first communication-node as stated above, and the second communication-node is configured to perform the method regarding with the second communication-node as stated above.

According to one aspect of this disclosure, there is provided an apparatus for implementing the method in any possible implementation of the foregoing aspects.

The method disclosed herein provides various benefits.

For example, the method disclosed herein adapts a diffusion model (DM) with guidance mechanism in physical layer of communication systems such as wireless communication systems, thereby providing performance improvement over discriminative models in complex PHY problem sets.

By using the communication-aware first AI model to act as a dedicated guidance mechanism, the method disclosed herein enables the DM model to learn and generate more accurate solutions, make the approach applicable to a wider range of communication scenarios, and use relaxed signal assumptions.

By using a standard-DDPM-like sampling process, the method disclosed herein avoids making approximations about the initial signal used in the prediction process (which may otherwise lead to sampling performance degradation).

### BRIEF DESCRIPTION OF THE DRAWINGS

For a more complete understanding of this disclosure, reference is made to the following description and accompanying drawings, in which:

FIGS. 1A and 1B are simplified schematic diagrams showing the structure of a communication system, according to some implementations of this disclosure;

FIG. 2A is a simplified schematic diagram showing a user equipment (UE), a terrestrial transmit-and-receive point (T-TRP), and a non-terrestrial transmit-and-receive points (NT-TRP) of the communication system shown in FIG. 1A;

FIG. 2B is a simplified schematic diagram showing units or modules in a device, such as in UE or in TRP of the communication system shown in FIG. 1A;

FIG. 3 is a simplified schematic diagram showing the forward and reverse diffusion processes of a diffusion model (DM), according to some implementations of this disclosure;

FIG. 4 is a simplified schematic diagram showing the structure of a signal-processing module in the form of a wireless communication receiver using a DM-based framework for performing signal detection, according to some implementations of this disclosure;

FIG. 5 is a simplified schematic diagram showing the structure of the DM-based framework in the form of a noise prediction neural network (NPNN) module of the signal-processing module shown in FIG. 4, according to some implementations of this disclosure;

FIG. 6 is a simplified schematic diagram showing the architecture of a conditional encoder of the DM-based framework shown in FIG. 5, according to some implementations of this disclosure;

FIG. 7 is simplified schematic diagram showing the training and sampling processes of the DM-based framework shown in FIG. 5, according to some implementations of this disclosure;

FIG. 8 shows an example of an algorithm for a training process of the DM-based framework shown in FIG. 5, according to some implementations of this disclosure;

FIG. 9 shows an example of an algorithm for a sampling process of the DM-based framework shown in FIG. 5, according to some implementations of this disclosure;

FIG. 10 shows an example of an algorithm for adaptation of the DM-based framework shown in FIG. 5 to a specific physical layer problem in a communication system, according to some implementations of this disclosure;

FIGS. 11A and 11B are plots showing the performance comparison in terms of uncoded Bit Error Rate (BER) (FIG. 11A) and coded BER (FIG. 11B) between the DM-based framework shown in FIG. 5 and some conventional methods; and

FIG. 12 is a plot showing the performance comparison in terms of the Peak-to-Average Power Ratio (PAPR) properties of pre-distorted signal generated by the DM-based framework shown in FIG. 5 and the conventional Alternating Direction Method of Multipliers (ADMM) method.

### DETAILED DESCRIPTION

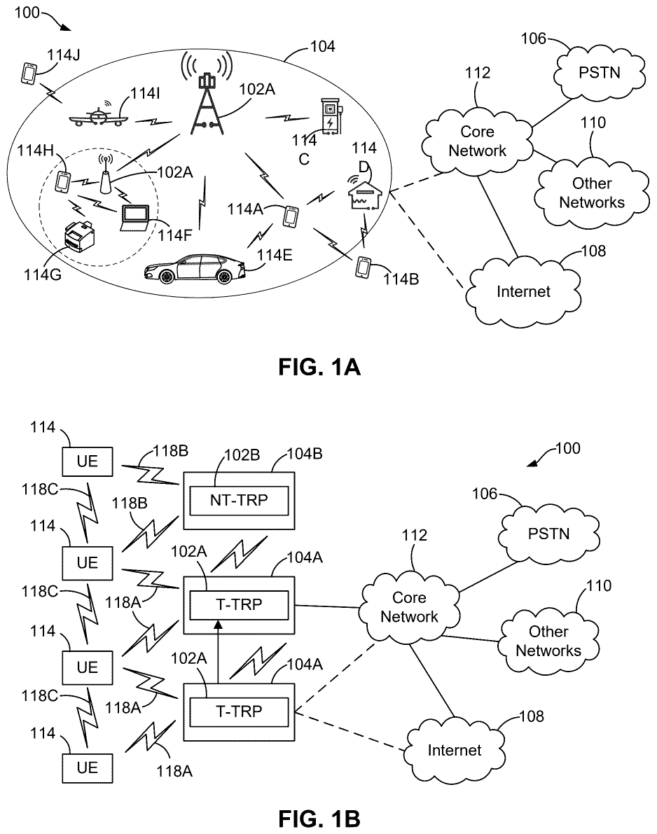

Referring to FIG. 1A, as an illustrative example without limitation, a simplified schematic illustration of a communication system is provided. The communication system 100 is in the form of a mobile communication system and comprises a radio access network (RAN) 104. The RAN 104 may be a next generation (for example, sixth generation (6G) or later) RAN, or a legacy (for example, fifth-generation (5G), fourth-generation (4G), third-generation (3G), or second-generation (2G)) RAN. One or more user equipments (UEs) 114A to 114J (generically referred to as 114) may be interconnected to one another or connected to one or more network nodes 102A in the RAN 104. A core network 112 may be a part of the communication system and may be dependent or independent of the radio access technology used in the communication system 100. Also the communication system 100 comprises a public switched telephone network (PSTN) 106, the internet 108, and other networks 110.

FIG. 1B illustrates an example communication system 100. In general, the communication system 100 enables multiple wireless or wired elements to communicate data and other content. The purpose of the communication system 100 may be to provide content, such as voice, data, video, and/or text, via broadcast, multicast, groupcast, and unicast, and/or the like. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, and/or the like). The communication system 100 may provide a high degree of availability and robustness through a joint operation of the terrestrial communication system and the non-terrestrial communication system. For example, integrating a non-terrestrial communication system (or components thereof) into a terrestrial communication system may result in what may be considered a heterogeneous network comprising multiple layers. As those skilled in the art will appreciate, the heterogeneous network may achieve improved overall performance through efficient multi-link joint operation, more flexible functionality sharing, and faster physical layer link switching between terrestrial networks (TNs) and non-terrestrial networks (NTNs).

The terrestrial communication system and the non-terrestrial communication system may be considered sub-systems of the communication system 100. In the example shown, the communication system 100 includes UEs 114, RANs 104A (also called “terrestrial communication networks”), non-terrestrial communication networks 104B, a core network 112, a public switched telephone network (PSTN) 106, the internet 108, and other networks 110. The RANs 104A include respective base stations (BSs) 102A, which may be generically referred to as terrestrial transmit-and-receive points (T-TRPs) 102A. The non-terrestrial communication network 104B includes an access node 102B, which may be generically referred to as a non-terrestrial transmit-and-receive point (NT-TRP) 102B. The T-TRPs 102A and the NT-TRP 102B may be generally referred to as TRPs or access nodes 102.

Any UE 114 may be alternatively or additionally configured to interface, access, or communicate with any other T-TRP 102A and NT-TRP 102B, the internet 108, the core network 112, the PSTN 106, the other networks 110, or any combination of the preceding. In some examples, UE 114 may communicate an uplink (UL) and/or downlink (DL) transmission over a terrestrial interface 118A with T-TRP 102A. In some examples, A UE 114 may communicate a UL and/or DL transmission over a non-terrestrial interface 118B with NT-TRP 102B. In some examples, the UEs 114 may also communicate directly with one another via one or more sidelink air interfaces 118C.

The air interfaces 118A and 118C may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA; also known as discrete Fourier transform spread OFDMA, DFT-s-OFDMA) in the air interfaces 118A and 118C. The air interfaces 118A and 118C may utilize other higher dimension signal spaces, which may involve a combination of orthogonal and/or non-orthogonal dimensions.

The non-terrestrial air interface 118B may enable communication between a UE 114 and one or multiple NT-TRPs 102B via a wireless link or simply a link. For some examples, the link is a dedicated connection for unicast transmission, a connection for broadcast transmission, or a connection between a group of UEs 114 and one or multiple NT-TRPs 102B for multicast transmission.

The RANs 104A are in communication with the core network 112 to provide the UEs 114 with various services such as voice, data, and other services. The RANs 104A and/or the core network 112 may be in direct or indirect communication with one or more other RANs (not shown), which may or may not be directly served by core network 112, and may or may not employ the same radio access technology as RANs 104A. The core network 112 may also serve as a gateway access between (i) the RANs 104A, or UEs 114, or both, and (ii) other networks (such as the PSTN 106, the internet 108, and the other networks 110). In addition, some or all of the UEs 114 may include functionality for communicating with different wireless networks over different wireless links using different wireless technologies and/or protocols. Instead of wireless communication (or in addition thereto), the UEs 114 may communicate via wired communication channels to a service provider or switch (not shown), and to the internet 108. PSTN 106 may include circuit switched telephone networks for providing plain old telephone service (POTS). Internet 108 may include a network of computers and subnets (intranets) or both, and incorporate protocols, such as internet protocol (IP), transmission control protocol (TCP), user datagram protocol (UDP). UEs 114 may be multimode devices capable of operation according to multiple radio access technologies, and incorporate multiple transceivers necessary to support such.

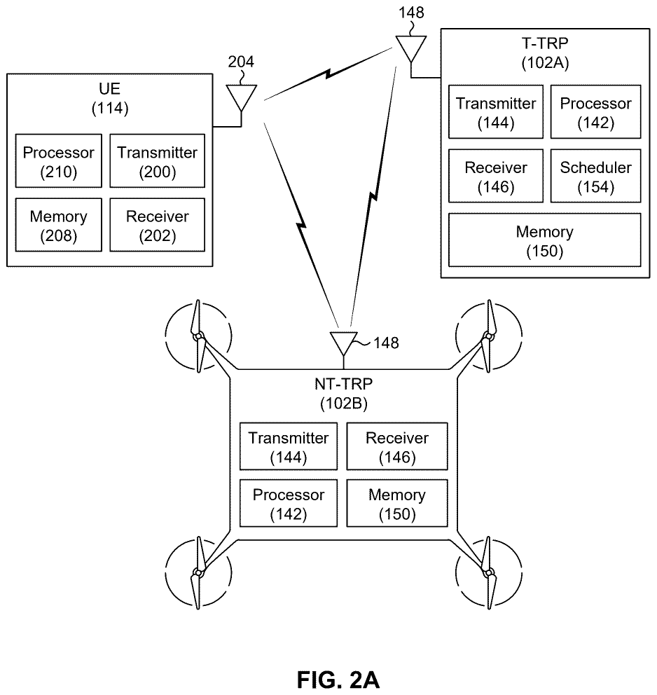

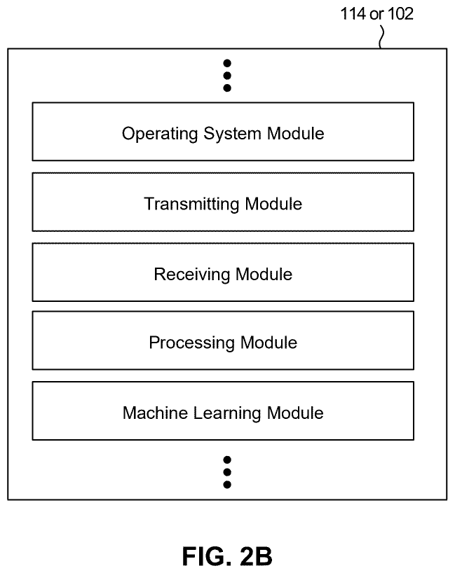

FIG. 2A illustrates an example of a UE 114, a T-TRP 102A, and a NT-TRP 102B. The UE 114 is used to connect persons, objects, machines, and/or the like. The UE 114 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, and/or the like.

Each UE 114 represents any suitable end-user device for wireless operation and may include such devices (or may be referred to) as a user device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, a wearable device (such as a watch, a pair of glasses, a head mounted equipment, and/or the like), an industrial device, a robot, or apparatus (for example, communication module, modem, or chip) in or comprising the forgoing devices, among other possibilities. Future generation UEs 114 may be referred to using other terms. Each UE 114 connected to T-TRP 102A and/or NT-TRP 102B may be dynamically or semi-statically turned-on (that is, established, activated, or enabled), turned-off (that is, released, deactivated, or disabled) and/or configured in response to one of more of: connection availability and connection necessity.

The T-TRP 102A may be known by other names in some implementations, such as a base station, a base transceiver station (BTS), a radio base station, a network node, a network device, a device on the network side, a transmit/receive node, a Node B, an evolved NodeB (eNodeB or eNB), a home eNodeB, a next generation NodeB (gNB), a transmission point (TP), a site controller, an access point (AP), or a wireless router, a relay station, a remote radio head, a terrestrial node, a terrestrial network device, or a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 102A may be macro BSs, pico BSs, relay node, donor node, or the like, or combinations thereof. The T-TRP 102A may refer to the forgoing devices or refer to an apparatus (for example, a communication module, a modem, a chip, or the like) in the forgoing devices.

In some implementations, the parts of the T-TRP 102A may be distributed. For example, some of the modules of the T-TRP 102A may be located remote from the equipment housing the antennas of the T-TRP 102A, and may be coupled to the equipment housing the antennas over a communication link (not shown) sometimes known as front haul, such as common public radio interface (CPRI). Therefore, in some implementations, the term T-TRP 102A may also refer to modules on the network side that perform processing operations, such as determining the location of the UE 114, resource allocation (scheduling), message generation, and encoding/decoding, and that are not necessarily part of the equipment housing the antennas of the T-TRP 102A. The modules may also be coupled to other T-TRPs. In some implementations, the T-TRP 102A may actually be a plurality of T-TRPs that are operating together to serve the UE 114, for example, through coordinated multipoint transmissions.

The T-TRP 102A comprises one or more circuits (such as one or more electronic circuits and/or one or more optical circuits) forming various components. For example, the T-TRP 102 may comprise at least one transmitter 144 and at least one receiver 146 coupled to one or more antennas 148. Only one antenna 148 is illustrated. One, some, or all of the antennas may alternatively be panels. The transmitter 144 and the receiver 146 may be integrated as a transceiver. The T-TRP 102A may further comprise at least one processor 142 for performing operations including those related to: preparing a transmission for DL transmission to the UE 114, processing an UL transmission received from the UE 114, preparing a transmission for backhaul transmission to NT-TRP 102B, and processing a transmission received over backhaul from the NT-TRP 102B. Processing operations related to preparing a transmission for DL or backhaul transmission may include operations such as encoding, modulating, precoding (for example, multiple input multiple output (MIMO) precoding), transmit beamforming, and generating symbols for transmission. Processing operations related to processing received transmissions in the UL or over backhaul may include operations such as receive beamforming, and demodulating and decoding received symbols. The processor 142 may also perform operations relating to network access (for example, initial access) and/or DL synchronization, such as generating the content of synchronization signal blocks (SSBs), generating the system information, and/or the like. In some implementations, the processor 142 also generates the indication of beam direction, for example, BAI, which may be scheduled for transmission by a scheduler 154. The processor 142 performs other network-side processing operations described herein, such as determining the location of the UE 114, determining where to deploy NT-TRP 102B, and/or the like. In some implementations, the processor 142 may generate signaling, for example, to configure one or more parameters of the UE 114 and/or one or more parameters of the NT-TRP 102B. Any signaling generated by the processor 142 is sent by the transmitter 144. Note that “signaling”, as used herein, may alternatively be called control signaling. Dynamic signaling may be transmitted in a control channel, for example, a physical downlink control channel (PDCCH), and static or semi-static higher layer signaling may be included in a packet transmitted in a data channel, for example, in a physical downlink shared channel (PDSCH), in which case the signaling may be known as higher-layer signaling, static signaling, or semi-static signaling. Higher-layer signaling may also refer to radio resource control (RRC) protocol signaling or media access control-control element (MAC-CE) signaling.

A scheduler 154 may be coupled to the processor 142. The scheduler 154 may be included within or operated separately from the T-TRP 102A, which may schedule UL, DL, and/or backhaul transmissions, including issuing scheduling grants and/or configuring scheduling-free (for example, “configured grant”) resources. The T-TRP 102A may further comprise a memory 150 for storing information and data. The memory 150 stores instructions and data used, generated, or collected by the T-TRP 102A. For example, the memory 150 may store software instructions or modules configured to implement some or all of the functionality and/or implementations described herein and that are executed by the processor 142.

Although not illustrated, the processor 142 may form part of the transmitter 144 and/or receiver 146. Also, although not illustrated, the processor 142 may implement the scheduler 154. Although not illustrated, the memory 150 may form part of the processor 142.

The processor 142, the scheduler 154, the processing components of the transmitter 144, and the processing components of the receiver 146 may each be implemented by the same or different one or more processors that are configured to execute instructions stored in a memory, for example, in memory 150. Alternatively, some or all of the processor 142, the scheduler 154, the processing components of the transmitter 144, and the processing components of the receiver 146 may be implemented using dedicated circuitry, such as a field-programmable gate array (FPGA), a graphical processing unit (GPU), or an application-specific integrated circuit (ASIC).

Although the NT-TRP 102B is illustrated as a drone only as an example, the NT-TRP 102B may be implemented in any suitable non-terrestrial form, such as satellites and high altitude platforms, including international mobile telecommunication base stations and unmanned aerial vehicles, for example. Also, the NT-TRP 102B may be known by other names in some implementations, such as a non-terrestrial node, a non-terrestrial network device, or a non-terrestrial base station.

The NT-TRP 102B comprises one or more circuits (such as one or more electronic circuits and/or one or more optical circuits) forming various components, and may have a similar structure as the T-TRP 102A. For example, the NT-TRP 102B may comprise a transmitter 144 and a receiver 146 coupled to one or more antennas 148. Only one antenna 148 is illustrated to avoid congestion in the drawing. One, some, or all of the antennas may alternatively be panels. The transmitter 144 and the receiver 146 may be integrated as a transceiver. The NT-TRP 102B further includes at least one processor 142 for performing operations including those related to: preparing a transmission for DL transmission to the UE 114, processing an UL transmission received from the UE 114, preparing a transmission for backhaul transmission to T-TRP 102A, and processing a transmission received over backhaul from the T-TRP 102A. Processing operations related to preparing a transmission for DL or backhaul transmission may include operations such as encoding, modulating, precoding (for example, MIMO precoding), transmit beamforming, and generating symbols for transmission. Processing operations related to processing received transmissions in the UL or over backhaul may include operations such as receive beamforming, and demodulating and decoding received symbols. In some implementations, the processor 142 implements the transmit beamforming and/or receive beamforming based on beam direction information (for example, BAI) received from T-TRP 102A.

In some implementations, the processor 142 may generate signaling, for example, to configure one or more parameters of the UE 114. In some implementations, the NT-TRP 102B implements physical layer processing, but does not implement higher layer functions such as functions at the medium access control (MAC) or radio link control (RLC) layer. As this is only an example, more generally, the NT-TRP 102B may implement higher layer functions in addition to physical layer processing.

The NT-TRP 102B further includes a memory 150 for storing information and data. Although not illustrated, the processor 142 may form part of the transmitter 144 and/or receiver 146. Although not illustrated, the memory 150 may form part of the processor 142.

The processor 142, the processing components of the transmitter 144, and the processing components of the receiver 146 may each be implemented by the same or different one or more processors that are configured to execute instructions stored in a memory, for example, in memory 150. Alternatively, some or all of the processor 142, the processing components of the transmitter 144, and the processing components of the receiver 146 may be implemented using dedicated circuitry, such as a programmed FPGA, a hardware accelerator (for example, a GPU or artificial intelligence (AI) accelerator), or an ASIC. In some implementations, the NT-TRP 102B may actually be a plurality of NT-TRPs that are operating together to serve the UE 114, for example, through coordinated multipoint transmissions.

The T-TRP 102A, the NT-TRP 102B, and/or the UE 114 may include other components, but these have been omitted for the sake of clarity.

The UE 114 comprises one or more circuits (such as one or more electronic circuits and/or one or more optical circuits) forming various components. More specifically, the UE 114 includes a transmitter 200 and a receiver 202 coupled to one or more antennas 204. Only one antenna 204 is illustrated to avoid congestion in the drawing. One, some, or all of the antennas may alternatively be panels. The transmitter 200 and the receiver 202 may be integrated, for example, as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The UE 114 includes at least one memory 208. The memory 208 stores instructions and data used, generated, or collected by the UE 114. For example, the memory 208 may store software instructions or modules configured to implement some or all of the functionality and/or implementations described herein and that are executed by at least one processing unit (for example, the at least one processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The UE 114 may further include one or more input/output devices (not shown) or interfaces (such as a wired interface to the internet 108 in FIG. 1A). The input/output devices permit interaction with a user or other devices in the network. Each input/output device includes any suitable structure for providing information to or receiving information from a user, and/or for network interface communications. Suitable structures include, for example, a speaker, a microphone, a keypad, a keyboard, a display, a touch screen, a network interface, and/or the like.

The UE 114 further includes at least one processor 210 for performing operations including those operations related to preparing a transmission for UL transmission to the T-TRP 102A and/or NT-TRP 102B, those operations related to processing DL transmissions received from the T-TRP 102A and/or NT-TRP 102B, and those operations related to processing sidelink transmission to and from another UE 114. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Depending upon the implementation, a DL transmission may be received by the receiver 202, possibly using receive beamforming, and the processor 210 may extract signaling from the DL transmission (for example, by detecting and/or decoding the signaling). An example of signaling may be a reference signal transmitted by the T-TRP 102A and/or NT-TRP 102B. In some implementations, the processor 142 implements the transmit beamforming and/or the receive beamforming based on the indication of beam direction, for example, beam angle information (BAI), received from T-TRP 102. In some implementations, the processor 210 may perform operations relating to network access (for example, initial access) and/or DL synchronization, such as operations relating to detecting a synchronization sequence, decoding and obtaining the system information, and/or the like. In some implementations, the processor 210 may perform channel estimation, for example, using a reference signal received from the T-TRP 102A and/or NT-TRP 102B.

Although not illustrated, the processor 210 may form part of the transmitter 200 and/or part of the receiver 202. Although not illustrated, the memory 208 may form part of the processor 210.

The processor 210, the processing components of the transmitter 200, and the processing components of the receiver 202 may each be implemented by the same or different one or more processors that are configured to execute instructions stored in a memory (for example, in memory 208). Alternatively, some or all of the processor 210, the processing components of the transmitter 200, and the processing components of the receiver 202 may be implemented using dedicated circuitry, such as a programmed FPGA, an ASIC, or a hardware accelerator such as a GPU or an AI accelerator.

One or more steps of the implementation methods provided herein may be performed by corresponding units or modules, according to FIG. 2B. FIG. 2B illustrates units or modules in a device, such as in a UE 114 or in a TRP 102. For example, a signal may be transmitted by a transmitting unit or a transmitting module. A signal may be received by a receiving unit or a receiving module. A signal may be processed by a processing unit or a processing module. Other steps may be performed by an AI or machine learning (ML) module. The respective units or modules may be implemented using hardware, one or more components or devices that execute software, or a combination thereof. For instance, one or more of the units or modules may be an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the UEs 114 and TRP 102 are known to those of skill in the art. As such, these details are omitted here.

MIMO technology allows an antenna array of multiple antennas to perform signal transmissions and receptions to meet high transmission rate requirement. The UEs 114 and/or TRPs 102 may use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above TRP 102 configured with a large number of antennas has gained wide attentions from the academia and the industry. In the large-scale MIMO system, the TRP 102 may be generally configured with more than ten antenna units (such as antennas 148 shown in FIG. 2A), and serves for dozens of the UE 114 in the meanwhile. A large number of antenna units of the TRP 102 may greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the TRP 102 of each cell may communicate with many UEs 114 in the cell on the same time-frequency resource at the same time, thus greatly increasing the spectrum efficiency. A large number of antenna units of the TRP 102 also enable each user to have improved spatial directivity for UL and DL transmission, so that the transmitting power of the TRP 102 and/or a UE 114 is obviously reduced, and the power efficiency is greatly increased. When the antenna number of the TRP 102 is sufficiently large, random channels between each UE 114 and the TRP 102 may approach to be orthogonal, and the interference between the cell and the users and the effect of noises may be eliminated. The plurality of advantages described above enable the large-scale MIMO to have a magnificent application prospect.

A MIMO system may include a receiver connected to a receiving (Rx) antenna, a transmitter connected to transmitting (Tx) antenna, and a signal processor connected to the transmitter and the receiver. Each of the Rx antenna and the Tx antenna may include a plurality of antennas. For instance, the Rx antenna may have a uniform linear array (ULA) antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some implementations of a MIMO system include:
Panel: unit of antenna group, or antenna array, or antenna sub-array which may control its Tx or Rx beam independently.
Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, antenna port(s) identifier, channel state information reference signal (CSI-RS) resource identifier, SSB resource identifier, sounding reference signal (SRS) resource identifier, codebook indication, beam direction indication, other reference signal resource identifier, and/or the like.

One of the useful and/or helpful tasks of the physical layer of a communication system 100 is symbol detection, wherein the goal is to minimize the error probability of the detected symbols.

Artificial intelligence is driving the evolution of 6G networks by providing innovative solutions to complex wireless communication challenges. Generative models, including generative adversarial networks, variational autoencoders, and transformers, are promising solutions to face various wireless communication challenges.

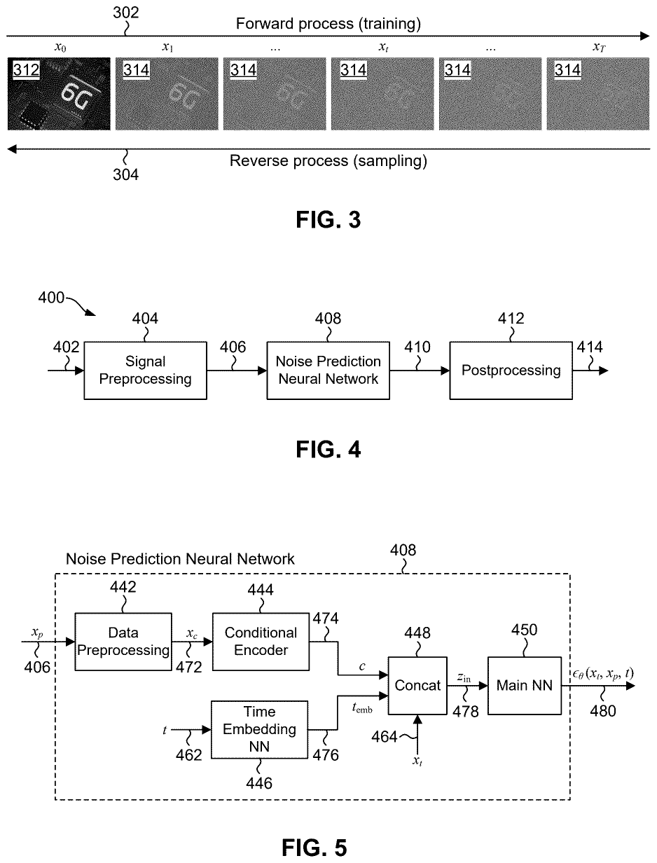

Diffusion models (DMs) are a class of generative models designed to learn complex data distributions. They achieve this by iteratively transforming simple noise distributions into data distributions through a two-step process. As shown in FIG. 3, in the forward process 302 (that is, the training process), data 312 (such as an image) is progressively corrupted into a noise distribution q(xₜ|xₜ₋₁). The reverse process 304 (that is, the sampling process) reconstructs the data 312 by learning p_{θ}(xₜ₋₁|xₜ). Both processes 302 and 304 are typically parameterized as Markov chains.

The forward process 302 incrementally adds Gaussian noise over T discrete time-steps (also simply denoted “steps”). This progressively corrupts the original data x₀ (that is, data 312), resulting in a series of increasingly noisy samples xₜ (also denoted 314). The distribution of the corrupted data at time-step t is given by q(xₜ|x₀). The reverse process 304 involves sampling from a learned distribution to sequentially remove noise and recover x₀. This bidirectional framework provides a flexible mechanism for generating high-quality samples. The mathematical formulation of this process centers on minimizing a variational bound between the true and model distributions.

DM have shown promise in various physical layer (PHY) tasks, such as decoding, channel estimation, signal detection, and synthetic channel generation in end-to-end learning architectures. However, such works, while promising, encounter two limitations in their current form.

Firstly, these DM-based methods rely on the assumption of Gaussian signal model, which often fails to accurately capture the complex, non-Gaussian nature of real-world communication environment (such as real-world wireless communication environment). This mismatch between the idealized Gaussian model and the actual channel conditions can degrade the performance of DM-based systems, especially in challenging conditions.

Additionally, some DM-based methods tend to be highly specialized, and designed for specific tasks or scenarios. This limited scope hinders their adaptability to diverse PHY problems. For instance, a DM-based method developed for a channel estimation task may not be easily applied to a signal detection task.

The DM method often employed in some works is the Denoising Diffusion Probabilistic Model (DDPM). These works directly apply the DDPM to their specific problems. In some works, the denoising diffusion implicit model (DDIM) is applied to accelerate the sampling process. In the following, a brief overview of the DDPM and DDIM is described with the limitations faced by some of these approaches.

DDPM is a generative modeling framework that utilizes a Markovian process to transform data x₀ into a Gaussian noise distribution. Subsequently, it learns the reverse process 304 to reconstruct x₀. This framework comprises at least two key components: the forward process 302 and the reverse process 304.

The forward process 302, also known as the diffusion process, incrementally corrupts the data x₀ over T discrete time-steps by adding Gaussian noise. At each time-step t, the data 312 is transformed as follows:

$$q ( {x}_{t} \vert {x}_{t - 1} ) = N ( {x}_{t} ; \sqrt{1 - {β}_{t}} {x}_{t - 1} , {β}_{t} I ) \qquad ( 1 )$$

where βₜ∈(0, 1) is a noise variance schedule that controls the amount of noise added at each time-step t (that is, the noise variance schedule refers to the way in which the mean and variance of the added noise changes over the course of the diffusion process; in other words, the noise variance schedule determines how the magnitude of the noise varies over the course of the diffusion process). Moreover, the notation N(μ,Σ) represents a Gaussian distribution with mean vector μ and covariance matrix Σ, and the notation N(x; μ, Σ) represents a Gaussian distribution parameterized by x, with mean vector μ and covariance matrix Σ. In simpler terms, the first notation N(μ,Σ) indicates the distribution that random vector x follows (denoted “x~N(μ,Σ)”), while the second notation N(x; μ, Σ) defines a Gaussian distribution with specific parameters (denoted “x~N(x; μ,Σ)”).

By compounding the noise over T time-steps, the marginal distribution at any time t is given as:

$$q ( {x}_{t} \vert {x}_{0} ) = N ( {x}_{t} ; \sqrt{{\overline{α}}_{t}} {x}_{0} , ( 1 - {\overline{α}}_{t} ) I ) \qquad ( 2 )$$

where αₜ=1−βₜ and

$${\overline{α}}_{t} = {\prod }_{s = 1}^{t} {α}_{s} .$$

As T→∞, the data distribution q(x_{T}) converges to a standard Gaussian distribution, N(0,I). This ensures that the forward process 302 transforms any data distribution into a simple noise distribution, from which the reverse process 304 begins.

The reverse process 304 is defined as a Markov chain parameterized by a neural network (NN) θ to model the conditional distributions p_{θ}(xₜ₋₁|xₜ). Starting from standard Gaussian noise x_{T}~N(0,I), the reverse process 304 iteratively removes noise from xₜ to recover x₀.

$${p}_{θ} ( {x}_{t - 1} \vert {x}_{t} ) = N ( {x}_{t - 1} ; {μ}_{θ} ( {x}_{t} , t ) , {\sum }_{θ} ( {x}_{t} , t ) ) \qquad ( 3 )$$

where μ_{θ}(xₜ,t) and Σ_{θ}(xₜ,t) represent the predicted mean and variance, respectively. Typically, Σ_{θ} is fixed during training to simplify the model. The mean μ₇₄ (xₜ,t) is computed using the NN output ∈₇₄ (xₜ,t), which predicts the added noise e in the data. Specifically, μ_{θ} is calculated as:

$${μ}_{θ} ( {x}_{t} , t ) = \frac{1}{\sqrt{{α}_{t}}} ( {x}_{t} - \frac{{β}_{t}}{\sqrt{1 - {\overline{α}}_{t}}} {ϵ}_{θ} ( {x}_{t} , t ) ) \qquad ( 4 )$$

This formulation ensures that the NN guides the reverse process 304 by iteratively reducing noise in xₜ, steering it toward the true data distribution.

The training objective for DDPM minimizes the Kullback-Leibler divergence between the true reverse distribution q(xₜ₋₁|xₜ,x₀) and the model distribution p_{θ}(xₜ₋₁|xₜ). This can be expressed as the following simplified objective, formulated as the MSE between the predicted noise and the actual noise:

$$L = {E}_{t , {x}_{0}} [ {‖ ϵ - {ϵ}_{θ} ( {x}_{t} , t ) ‖}^{2} ] , \qquad ( 5 )$$

where ∈~N(0,I). This loss function directly optimizes the denoising performance and facilitates stable training of the reverse process 304.

DDIM extends the DDPM framework by incorporating a deterministic reverse process. This modification accelerates the sampling process while maintaining the quality of generated outputs. The forward process 302 remains unchanged from DDPM, but the reverse process 304 is adjusted with a tunable parameter ηₜ to control the level of stochasticity. This increased control over the sampling process makes DDIM particularly attractive for real-time applications and computationally constrained environments. In DDIM, the reverse process 304 directly computes xₜ₋₁ from xₜ using the predicted noise ∈_{θ}(xₜ,t) and the intermediate predicted data \hat{x}ₜ:

$${x}_{t - 1} = \sqrt{{\overline{α}}_{t - 1}} {\hat{x}}_{0} + \sqrt{1 - {\overline{α}}_{t - 1} - {η}_{t}^{2}} {ϵ}_{θ} ( {x}_{t} , t ) + {η}_{t} ψ , \qquad ( 6 )$$

where 0≤ηₜ≤1 is a stochasticity parameter, and ω~N(0,I). The intermediate estimate \hat{x}₀ is defined as:

$${\hat{x}}_{0} = \frac{{x}_{t} - \sqrt{1 - {\overline{α}}_{t}} {ϵ}_{θ} ( {x}_{t} , t )}{\sqrt{{\overline{α}}_{t}}} . \qquad ( 7 )$$

To further accelerate sampling, DDIM utilizes a subset of time-steps τ={τ₁, τ₂, . . . , τ_{S}} from the original T time-steps used in DDPM, where τᵢ>τᵢ₋₁ and S<<T. This subset reduces redundancy in the sampling process while maintaining high fidelity in the generated outputs.

One of the noteworthy aspects of DDPM is that the reverse process begins with normal noise, i.e., x_{T}~N(0,I). Some DM-based approaches either assume or approximate the signal model as Gaussian, or they condition the model on additional information such as Channel State Information (CSI) to enable the Gaussian assumption. This approach is not only inaccurate for many wireless PHY problems but also necessitates the knowledge or estimation of these conditions, adding an extra layer of complexity.

Moreover, some of these methods tailor the DDPM to specific problem sets, making it difficult to generalize them to other scenarios. This limitation hinders the broader application of DM in PHY.

In the following, a DM-based framework is described, which enables the application of DDPM and DDIM to a wide class of wireless PHY problems. The DM-based framework disclosed herein leverages conditional denoising diffusion models to address a wide range of Physical layer challenges in wireless communication systems.

As will be described in more details below, the DM-based framework uses a conditional encoder (note that the conditional encoder is a concept in the field of artificial intelligence (AI) or more specifically in the field of generative models, and is different to the concept of “encoder” in communication technologies) to address the limitation of the Gaussian assumption in the reverse diffusion process. Herein, a generative model is a type of AI model (or more specifically a machine learning model) for learning the underlying patterns and structures of training data and, after training, generating new, similar data based on the input data. A generative model generally comprises an encoder and a decoder (also denoted a “generator”). The encoder of the generative model is responsible for transforming raw input data into a latent representation for capturing the essence of the input data, and highlighting one of the useful/helpful features thereof. The decoder of the generative model is responsible for reconstructing the data based on the learned patterns and relationships from the encoded space. In other words, the decoder translates the latent vectors into meaningful output data.

In the DM-based framework, the conditional encoder incorporates relevant problem-specific information (that is, the “conditions”) into the model, and expands the applicability of the DM-based framework to a wider range of signal models beyond Gaussian distributions. For instance, in signal detection problems, the condition may include data such as the received signal or the Additive White Gaussian Noise (AWGN) power. The encoder extracts these features and generates a high-dimensional encoded condition, denoted as c, which is then integrated into the DDPM framework as a guidance signal. This integration enables the DM-based framework to handle diverse signal models.

FIG. 4 is a schematic diagram showing the structure of a signal-processing module 400 in the form of a wireless communication receiver using the DM-based framework for performing signal or symbol detection, according to some implementations of this disclosure. For example, in some implementations, the receiver 400 may only have the knowledge of symbol constellation (binary phase-shift keying (BPSK), quadrature phase shift keying (QPSK), quadrature amplitude modulation (QAM), and/or the like), frequency band, OFDM size, subcarrier spacing (SCS), and/or the like, and have no knowledge of the channel characteristics, interference characteristics, noise characteristics, and/or the like. Unlike some signal detection methods, the receiver 400 in these implementations does not perform channel estimation. For example, while in some implementations, the signal transmitted from the transmitter may comprise pilot symbols, the pilot symbols may merely be used at receiver 400 for assessing the correctness of signal detection, and are not used for channel estimation.

As shown in FIG. 4, the received signal 402 (such as a radio frequency (RF) signal) is first preprocessed (404) as needed, such as signal amplifying, analog-to-digital conversion, and/or the like. Then, the preprocessed signal 406 is then sent to a noise prediction neural network (NPNN) module 408 for signal detection using the DM-based framework. The detected signal or symbols 410 may be postprocessed (412) for other purposes such as error detection, error correction, and/or the like, and the form an output signal 414.

Note that the term “noise” used hereinafter (such as in “noise prediction”) is a concept in the generative AI field, and is not necessarily the same as the concept of “noise” in the communication field. More specifically, the term “noise” used hereinafter (also called “perturbation”) refers to the perturbation or corruption introduced to the transmitted signal during the signal transmission through the communication channel, wherein such perturbation or corruption includes, for example, the additive noise, interferences, channel distortion, multi-path, and/or the like that make the received signal different from the transmitted signal.

FIG. 5 is a schematic diagram showing the structure of the NPNN module 408, according to some implementations of this disclosure. The NPNN 408 comprises a data preprocessing module 442, a conditional encoder 444 (which in this example is a convolutional neural network, and may be any other suitable neural network in other implementations), a time embedding layer 446 (which is a neural network), and a main NN 450 such as a U-Net (which is a convolutional neural network originally developed for image segmentation). In these implementations, the main NN 450 is responsible for noise or perturbation prediction.

As shown in FIG. 5, the preprocessed signal 406 (also denoted an “input xₚ”, which may be considered the observation of the problem or the problem-specific information) is processed by the data preprocessing module 442 to ensure dimensionality matching, and arranging the input xₚ into a preprocessed signal 472 (also denoted “x (”) of a predefined or preconfigured size such as a size of Dₕ×D_{w}×D_{ch} (excluding the batch size or dimension), which is sent to the conditional encoder 444 for processing. Those skilled in the art will appreciate that the data preprocessing module 442 may be optional. For example, in some implementations wherein the input xₚ is already organized in accordance with the predefined or preconfigured size requirement, the NPNN 408 may not comprise the data preprocessing module 442.

The conditional encoder 444 is meticulously designed to map all available observations of the problem (that is, xₚ or equivalently the preprocessed signal x_{c}), into a high-dimensional space to obtain an encoded input signal 474 (also denoted “c”). This ensures that the main NN 450 may effectively utilize this information to guide the model towards the desired output.

The time embedding layer 446 receives and encodes the time-step t (also denoted 462) to an encoded time-step signal 476.

The output 474 of the conditional encoder 444, the output 476 of the time embedding layer 446, and an additional input 464 (also denoted xₜ, which is the ideal solution's outcome, and may be the ground truth (for training) or the perturbated or corrupted input (for sampling)) are concatenated (448) to form a signal 478 (also denoted zᵢₙ) to send to the main NN 450 for training or for sampling or prediction.

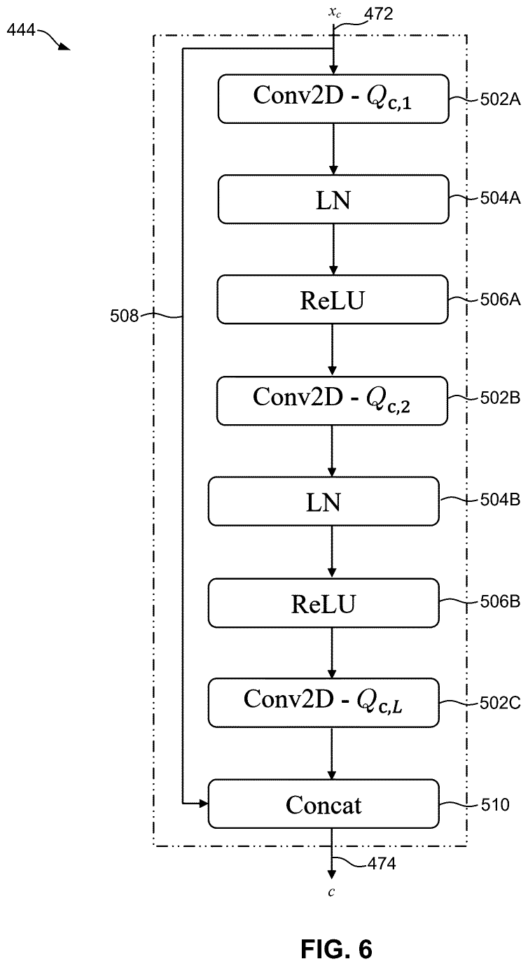

FIG. 6 is a schematic diagram showing the structure of the conditional encoder 444, according to some implementations of this disclosure. In these implementations, the conditional encoder 444 comprises a sequence of three convolutional layers 502A, 502B, and 502C (such as three two-dimensional (2D) convolutional layers (Conv2D)), with a layer normalization (LN) 504A and a rectified linear unit (ReLU) activation function 506A between the first and second 2D convolutional layers 502A and 502B, and a layer normalization 504B and a ReLU activation function 506B between the second and third 2D convolutional layers 502B and 502C. The inclusion of layer normalization (collectively denoted 506) aids in mitigating internal covariate shift, thereby stabilizing the learning process and enhancing the efficiency of training.

The first 2D convolution layer receives the preprocessed signal x_{c} (that is. 472) or equivalently the input xₚ (that is. 406), and the third 2D convolution layer generates the output c (that is, 474).

The convolutional layers (collectively denoted 502) employ kernel sizes Q_{c,1}, Q_{c,2}, and Q_{c,L}, where Q_{c,L} represents the latent space dimension. This dimension is judiciously selected to ensure Q_{c,L}>D_{ch}, empowering the conditional encoder 444 to capture richer feature representations from the input 406 (or equivalently the preprocessed signal 472). The kernel size at each convolutional layer 502 is a design parameter that may be fine-tuned based on the specific problem at hand. Alternatively, the kernel size may be set to a fixed number such as three (3) for effectiveness across a diverse range of scenarios.

To preserve both low-level input features and the higher-level abstractions learned by the network, a skip connection 508 is used to concatenate (510) the output of the final convolutional layer 502C with the original input 472 (that is, x_{c}). The resulting output 474 is:

$$c = {f}_{conEnc} ( {x}_{p} ) , \qquad ( 8 )$$

which serves as the encoded condition that is then integrated into the DDPM framework 408 as a guiding signal.

The time embedding layer 446 is useful and/or helpful for the model to condition its predictions on the specific time-step in the reverse diffusion process, and may be any suitable AI model such as that described in academic paper entitled “Denoising diffusion probabilistic models,” by Ho, et al., published in 34th Conference on Neural Information Processing Systems (NeurIPS 2020), Vancouver, Canada, 2020, the content of which is incorporated herein by reference in its entirety.

In these implementations, the time embedding layer 446 encode the time-step t in the diffusion process, transforming the scalar value t into a high-dimensional representation such as a high-dimensional continuous representation. This richer embedding allows the network to capture more intricate temporal dependencies and enhances the model's ability to learn the dynamics of the reverse process.

For example, if the time-step t is t=10, then, the value t=10 is passed to the time embedding layer 446, which encodes the value of 10 and outputs a real-valued vector (that is, the time embedding 476) having a size of, for example, 16. In other words, the value 10 of the time-step is now represented by a vector of size 16 with the real-valued elements.

The resulting time embedding 476 (also denoted t_{emb}) is generated with a dimension of Qₜ, where Qₜ is a hyperparameter that determines the size of the embedded space. The time embedding transformation is defined as:

$${t}_{emb} = {f}_{TimeEmb} ( t ) \qquad ( 9 )$$

The main NN 450 is employed for noise or perturbation prediction. In some implementations, the main NN 450 is based on the U-Net architecture (although in some other implementations, other NNs may be used), which is a widely recognized model in the DM literature. The detail of the U-Net architecture can be found in, for example, the academic paper entitled “U-Net: Convolutional networks for biomedical image segmentation,” by Ronneberger, et al., published in Medical Image Computing and Computer-Assisted Intervention (MICCAI), Springer, LNCS, Vol. 9351:234-241, 2015, the content of which is incorporated herein by reference in its entirety.

The U-Net is a convolutional neural network (CNN) and originally used in the context of image segmentation. The U-Net comprises an encoder-decoder pathway with skip connections. The encoder, or contracting path in U-Net architecture (or other NNs that may be used), captures context by progressively downsampling the input image through a series of convolutional and pooling layers, reducing spatial dimensions while increasing feature depth. This allows the network to learn hierarchical features, from low-level edges and textures to high-level structures. The decoder, or expansive path in the U-Net architecture (or in other NNs that may be used), performs upsampling through transposed convolutions or interpolation, gradually restoring the spatial resolution while combining high-resolution features from the encoder via skip connections. These skip connections bridge the gap between the encoder and decoder, enabling precise localization by preserving fine-grained details that might otherwise be lost during downsampling.

U-Net provides the ability to handle tasks requiring both global context and precise localization, making it particularly effective for medical imaging, which often requires accurate segmentation of structures such as organs or tumors. In addition to segmentation, U-Net has also been used in generative models (such as in diffusion models) and for tasks such as image synthesis and denoising. In diffusion models, U-Net is often used as the backbone architecture to predict and iteratively refine noise or signal during the reverse diffusion process. Its ability to process multi-scale features and maintain spatial coherence makes it suitable for modeling the complex distributions of data in diffusion frameworks.

In these implementations, the input zᵢₙ to the main NN 450 at time-step t is formed by concatenating three components: the high-dimensional condition c from the conditional encoder 444, the embedded time t_{emb} from the time embedding layer 446, and the additional input xₜ, which is either the ground truth (for training) or the noisy input (for sampling).

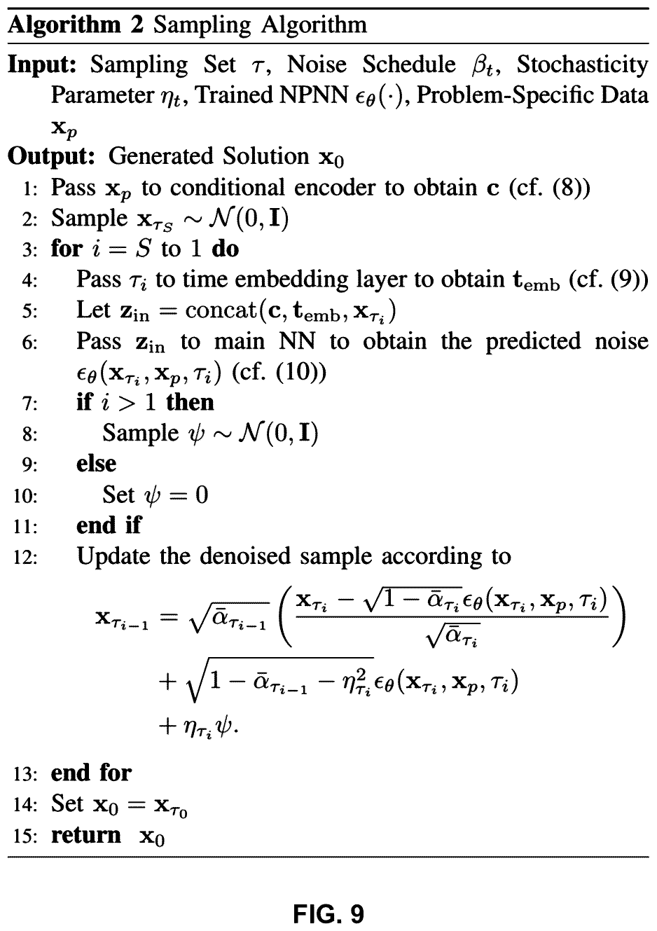

The inclusion of c and t_{emb} enriches the input, empowering the model to more effectively address specific tasks (such as the wireless communication tasks) and enhancing its flexibility across various signal models. The output 480 (also denoted “∈_{θ}(xₜ,xₚ,t)”) of the NPNN 408 is the predicted noise or perturbation to be removed or otherwise compensated (see step 12 of Algorithm 2 shown in FIG. 9 for an example of such removal of compensation) at the next time-step from the signal xₜ, which may be estimated as a function of the additional input xₜ, the input xₚ, and the time-step t, and may be computed using the main NN 450 as follows:

$${ϵ}_{θ} ( {x}_{t} , {x}_{p} , t ) = {f}_{MainNN} ( {z}_{in} ) \qquad ( 10 )$$

where θ represents all trainable weights or parameters of the NPNN 408 (that is, the NPNN 408 is parameterized by θ),

$${z}_{in} = concat ( c , {t}_{emb} , {x}_{t} ) , \qquad ( 11 )$$

and concat( ) represents the concatenation operation.

The calculation of xₜ is now described in the context of both the training and sampling stages.

The training phase of the NPNN 408 follows the general DDPM framework, and is enhanced by problem-specific conditioning through the conditional encoder 444. For training purposes, xₜ in Equation (11) is calculated as follows:

$${x}_{t} = \sqrt{{\overline{α}}_{t}} {x}_{0} + \sqrt{1 - {\overline{α}}_{t}} ϵ , \qquad ( 12 )$$

where ∈ is a random signal following the normal distribution (that is, ∈~N(0,I), where I represents the unity matrix), and is used during the training process to push the signal xₜ toward the normal-distribution and help the NPNN 408 to learn this process such that it can perform the inverse during the sampling process, x₀ is the desired outcome or the ground truth solution to the problem at hand, and α̅ₜ is defined above (see the description related to Equation (2)). The dataset D_{S} used for training the NPNN 408 comprises pairs of problem-specific inputs xₚ and their corresponding desired solutions x₀. In other words, each element of D_{S} is a tuple (xₚ,x₀), where xₚ contains all the available observations (for example, the signal received by the receiver), and x₀ is the desired solution (for example, the signal transmitted by the transmitter), which serves as the diffusion model's target. For instance, in a channel estimation task, the observations may include the received signals, pilot signals, and delay spread, while the corresponding desired solution may be the true channel state information (CSI).

The training objective of the NPNN 408 is to minimize the difference between the predicted perturbation ∈_{θ}(xₜ,xₚ,t) and the random signal ∈, which is achieved by optimizing a loss function derived from the evidence lower bound formulation, which ensures the model learns the reverse diffusion process. In some implementations, the loss is given by:

$${L}_{θ} = {E}_{{x}_{t} , {x}_{p} , t} [ {\vert {ϵ}_{θ} ( {x}_{t} , {x}_{p} , t ) - ϵ \vert}^{2} ] , \qquad ( 13 )$$

where Eₓ_{ₜ}_{,x}_{ₚ}_{,t}[•] represents the expectation with respect to xₜ, xₚ, and t.

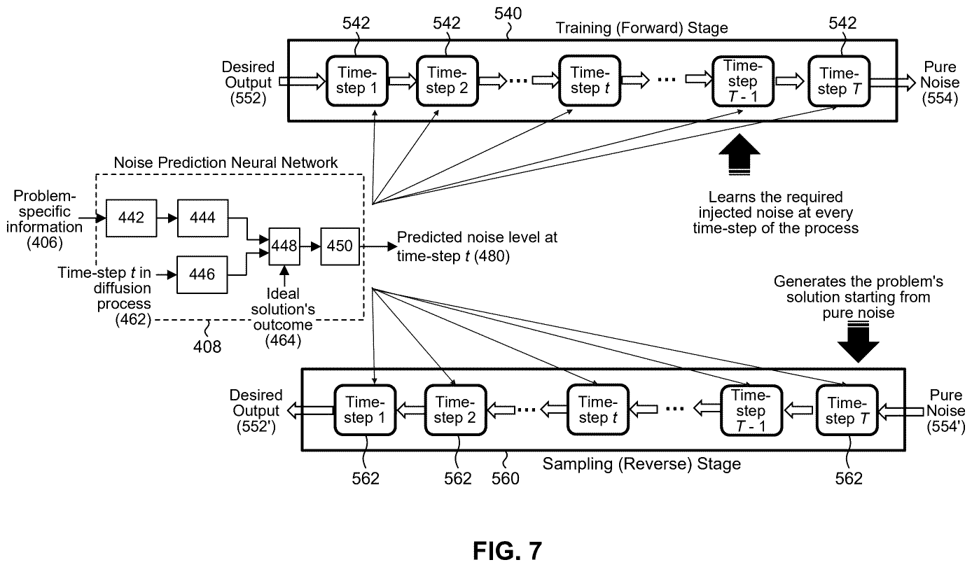

FIG. 7 is a simplified schematic diagram showing the training and sampling processes (also called the “forward” and “reverse” processes) 540 and 560 of the NPNN module 408, with each process comprising a plurality of T time-steps 542 or 562. In each time-step t, the NPNN module 408 receives problem-specific information 406, the time-step 462, and the additional input 464, and outputs predicted perturbation 480.

More specifically, the training process 540 starts with the desired output 552 as the initial input for the NPNN module 408, and goes through T time-steps 542 (from time-step 1 to time-step T) to learn the required injected perturbation at every time-step 542, and eventually outputs pure noise or perturbation 554.

The sampling process 560 starts with pure noise or perturbation 554′ as the initial input for the NPNN module 408, and goes through T time-steps 562 (from time-step T to time-step 1) to generate and output the problem's solution 552′.

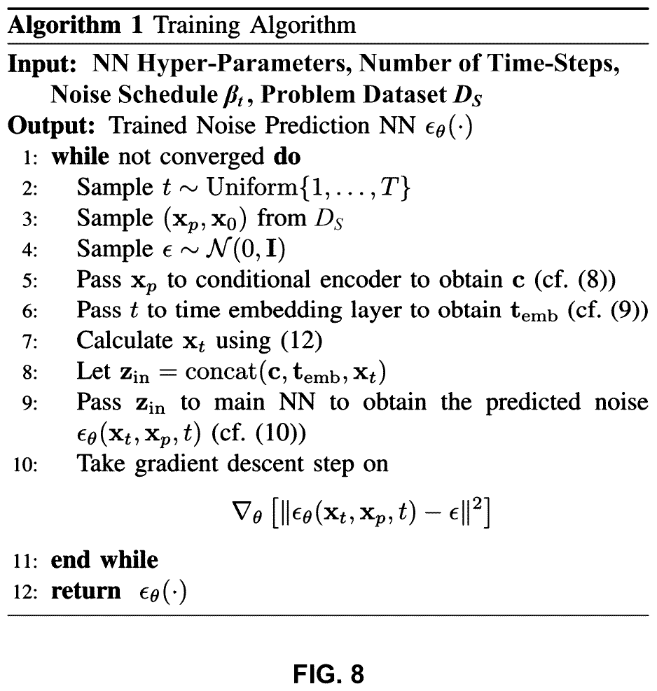

An example of the training process 540 is outlined in Algorithm 1 shown in FIG. 8. In this example, Algorithm 1 uses predefined or preconfigured NN hyper-parameters for the neural networks 444, 446, and 450. A total number of time-steps T, a noise variance schedule βₜ, and a problem dataset D_{S}.

As shown, the training process randomly samples a time-step t from the set of {1, . . . , T} in accordance with a uniform distribution (step 2), obtains a tuple (xₚ,x₀) from the training dataset D_{S} (step 3), and obtains a sample of the random signal e in accordance with the normal distribution N(0,I) (step 4). Then, xₚ (that is, 406) is passed to the conditional encoder 444 to obtain c (that is, 474) in accordance with Equation (8) (step 5).

At step 6, the time-step t (that is, 462) is passed to the time embedding layer 446 to obtain t_{emb} (that is, 476) in accordance Equation (9).

At step 7, xₜ (that is, 464) is calculated in accordance Equation (12).

At step 8, c, t_{emb}, and xₜ are concatenated to form zᵢₙ (that is, 478) in accordance Equation (11).

At step 9, zᵢₙ is passed to the main NN 450 to obtain the predicted noise or perturbation ∈_{θ}(xₜ,xₚ,t) (that is, 480) in accordance Equation (10).

At step 10, the gradient descent step is obtained by calculating:

$${∇}_{θ} [ {‖ {ϵ}_{θ} ( {x}_{t} , {x}_{p} , t ) - ϵ ‖}^{2} ] , \qquad ( 14 )$$

The main NN 450 is then updated based on the gradient decent step, and the process repeats steps 2 to 10 until the loss function L_{θ} (see Equation (13) converges (or equivalently, ∈_{θ}(xₜ,xₚ,t) converges to ∈). The trained NPNN 408 (denoted “∈_{θ}(·)”) is then obtained.

The trained NPNN 408 may be used for the sampling process.

In some DDPM sampling processes, the model iteratively denoises the input over T time-steps, starting from Gaussian noise, x_{T}, and gradually generating a denoised sample, x₀. In some scenarios relating to the DM to PHY problems, the sampling process begins with a corrupted communication signal instead of Gaussian noise, implicitly assuming that the signal model originates from a normal distribution. However, the NPNN 408 does not make this assumption. Instead, all relevant observations are passed to the conditional encoder 444, and the NPNN 408 begins the sampling process with time-step t=T, and xₜ=x_{T}~N(0,I), in full accordance with the DDPM framework.

In some implementations, to accelerate the sampling process, the NPNN 408 may adopt the DDIM method described above and utilizes a subset of time-steps τ={τ₁, τ₂, . . . , τ_{S}} from the original T time-steps used in DDPM, where τᵢ>τᵢ₋₁ (that is, τ₁<τ₂< . . . <τ_{S}) and S<<T, to reduce the sampling iterations from T to S. The tunable parameter ηₜ in these implementations is problem-specific and may be chosen based on the task at hand. In some implementations, a fully stochastic approach (ηₜ=1) may yield the best results, while in some other implementations, a more deterministic approach (ηₜ=0) may be preferred.

An example of the sampling process 560 is outlined in Algorithm 2 shown in FIG. 9. In this example, Algorithm 2 uses S time-steps τ={τ₁, τ₂, . . . , τ_{S}}, a noise variance schedule βₜ, a stochasticity parameter ηₜ, a trained NPNN ∈₇₄ (·), and a problem-specific data xₚ.

At step 1, the input xₚ (that is, 406) is passed to the conditional encoder 444 to obtain c (that is, 474) in accordance with Equation (8).

At step 2, the sampling process obtains the additional input 464 x_{τ}_{_{S}} in accordance with the normal distribution N(0,I), that is, x_{τ}_{_{S}}~N(0,I).

The following steps 4 to 12 are repeated for S time-steps τ={τ₁, τ₂, . . . , τ_{S}} (that is, from i=S down to i=1), where S>1.

At step 4, τᵢ (that is, 462) is passed to the time embedding layer 446 to obtain t_{emb} (that is, 476) in accordance Equation (9).

At step 5, c, t_{emb}, and x_{τ}_{ᵢ} are concatenated to form zᵢₙ (that is, 478) in accordance Equation (11).

At step 6, zᵢₙ is passed to the main NN 450 to obtain the predicted or perturbation ∈_{θ}(x_{τ}_{ᵢ},xₚ,t) (that is, 480) in accordance Equation (10).

At step 7, the sampling process checks if i>1. If it determines that i>1, then the sampling process obtains ψ in accordance with the normal distribution (0,I), that is, ω~N(0,I) (step 8). Otherwise, if i=1, then ψ is set to zero (0), that is, ψ=0 (step 10).

At step 12, the sampling process updates or otherwise calculates the additional input 464 (which is a denoised signal or sample) according to:

$${x}_{{τ}_{i - 1}} = \sqrt{{\overline{α}}_{{τ}_{i - 1}}} ( \frac{{x}_{{τ}_{i}} - \sqrt{1 - {\overline{α}}_{{τ}_{i}}} {ϵ}_{θ} ( {x}_{{τ}_{i}} , {x}_{p} , {τ}_{i} )}{\sqrt{{\overline{α}}_{{τ}_{i}}}} ) + \sqrt{1 - {\overline{α}}_{{τ}_{i - 1}} - {η}_{{τ}_{i}}^{2}} {ϵ}_{θ} ( {x}_{{τ}_{i}} , {x}_{p} , {τ}_{i} ) + {η}_{{τ}_{i}} ψ . \qquad ( 15 )$$

where τᵢ is the current time-step, τᵢ₋₁ is a next time-step, x_{τ}_{ᵢ} is the denoised signal 464 in the current time-step τᵢ, x_{τ}_{_{i−1}} is the denoised signal 464 in the next time-step τᵢ₋₁, xₚ is the input signal 406, ∈_{θ}(x_{τ}_{ᵢ},xₚ,τᵢ) is the predicted perturbation,

$${\overline{α}}_{{τ}_{i}} = {\prod }_{k = 1}^{{τ}_{i}} {α}_{k} = {\prod }_{k = 1}^{{τ}_{i}} 1 - {β}_{k} , {β}_{k} ∈ ( 0 , 1 )$$

is a noise variance schedule at a time-step k, and 0≤η_{τ}_{ᵢ}≤1 is a stochasticity parameter.

Once the repeating of steps 4 to 12 is completed, x₀ is set to x_{τ}_{₀} (step 14), and at step 15, x₀ is outputted as the solution (that is, the output of the NPNN 408; for example, the detected signal or symbols).

Research and simulations have shown that the above-described sampling process requires much fewer sampling iterations compared to other DDPM methods.

Those skilled in the art will appreciate that the DM-based framework disclosed herein is not limited to the above-described implementations, and indeed provides a versatile method for addressing a wide range of PHY problems. To adapt the DM-based framework to a specific task, the relevant input observations that will be fed into the conditional encoder 444 need to be identified. These observations need to contain useful and/or helpful information without redundancy. For instance, in a channel estimation problem, the transmitted and received pilot signals may be sufficient inputs, rendering additional information such as AWGN power redundant.

Moreover, the ideal solution, or ground truth, that the model aims to replicate need to be defined. While using true solution values during training can be a straightforward approach, generating ground truth using some methods under ideal scenarios often proves more effective. For example, in a beamforming design problem, some methods assuming perfect CSI and high SNR may be used to create the ground truth, enabling the model to learn to replicate this response without requiring such ideal conditions during sampling.

By following these principles, the DM-based framework disclosed herein may be effectively adapted to various wireless communication challenges.

Another useful and/or helpful consideration is selecting the appropriate NN hyperparameters. It has been observed that increasing the number of kernels in the U-Net allows the model to capture more complex relationships. However, while the conditional encoder 444 may need to be sufficiently large, further increasing its size does not necessarily improve performance. The learning rate is another helpful and/or useful hyperparameter, and typically values around 10⁻⁴ or smaller may be used. In addition, the noise variance schedule needs to be carefully chosen. For example, in some implementations, a sigmoid schedule, such as that described in the academic paper entitled “Denoising diffusion implicit models,” by Song, et al., published in the International Conference on Learning Representations (ICLR) 2021, the content of which is incorporated herein by reference in its entirety, may be used, ensuring that the variance spans the range from zero (0) to one (1) with high granularity.

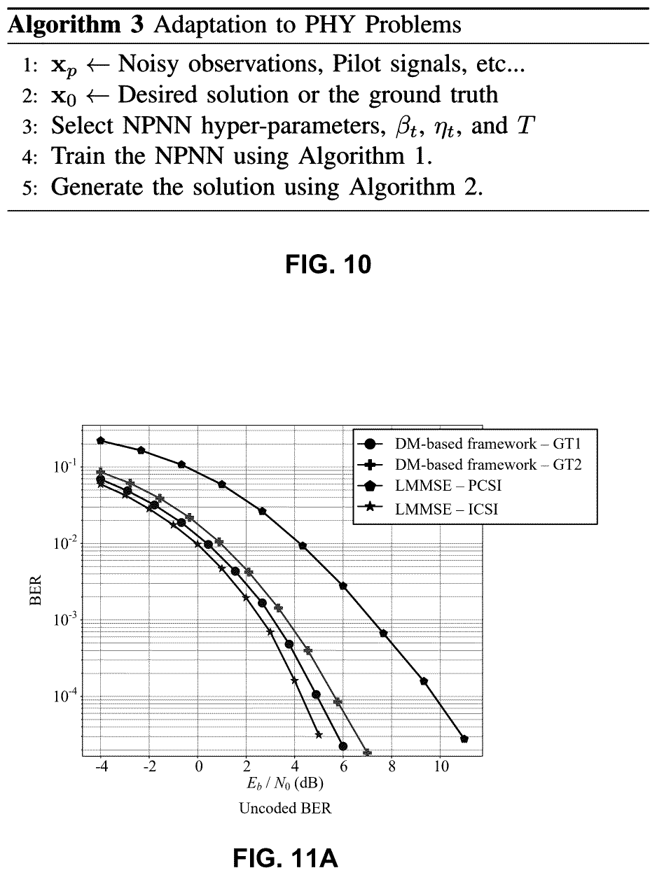

As an example, FIG. 10 shows Algorithm 3 which provides a step-by-step outline for adapting the DM-based framework disclosed herein to specific PHY problems.
At step 1, the input signal xₚ is set to noisy observations, pilot signals, and/or the like.
At step 2, x₀ is set to the desired solution or the ground truth solution to the problem at hand.
At step 3, NPNN hyperparameters such as a noise variance schedule βₜ, a stochasticity parameter ηₜ, T (that is, the number of original time-steps used in DDPM, which forms a set for selection to build the time-steps τ={τ₁, τ₂, . . . , τ_{S}} with S<<T), and/or the like are selected.
At step 4, the NPNN 408 is trained using Algorithm 1 shown in FIG. 8.
At step 5, the solution is generated using Algorithm 2 shown in FIG. 9.

Thos skilled in the art will appreciate that the DM-based framework disclosed herein is a versatile framework for addressing several classes of problems, including a wide range of PHY problem sets such as parameter estimation, signal detection tasks, distortion compensation, channel estimation, predistortion, and/or the like.

The DM-based framework disclosed herein may be deployed on TRPs 102 and/or UEs 114.

Furthermore, the DM-based framework disclosed herein is applicable to both transmitter and receiver sides depending on the problem to be solved. Some examples are now described.

### Example 1

In some implementations, the DM-based framework disclosed herein may be used on the receiver side for signal detection in uplink.

In this example, the uplink is an OFDM uplink where a single-antenna UE 114 transmits to an eight-antenna TRP 102 over a Tapped Delay Line (TDL) channel model, following the 3GPP standards. Key parameters for the setup are provided in TABLE 1.

TABLE 1
PARAMETERS USED IN EXAMPLE 1

| Parameter | Value |
|---|---|
| Carrier Frequency | 2.5 GHz |
| Channel Model | TDL-D (Block Fading) |
| Maximum Delay Spread | 100 ns |
| OFDM Symbols per Frame | 14 |
| FFT size/CP Length/Subcarrier | 64/6/30 kHz |
| Spacing | |
| Signal Constellation | 16-QAM |
| Pilot Symbols per Frame/Pilot | 2/QPSK |
| Constellation | |
| FEC/Block Length/Code Rate | LDPC/1538/7/8 |
| Qc,1/Q_{c,2}/Q_{c,L}/Kernel Size/Qₜ | 64/64/128/(3, 3)/16 |
| Learning Rate/Training Epochs | 8 × 10⁻⁵/10000 |
| ηₜ/T/S | 1.0/500/15 |
| min(βₜ)/max(βₜ) | 5 × 10⁻⁴/10⁻² |

To adapt the DM-based framework at the receiver, the following settings are applied in accordance with Algorithm 3 shown in FIG. 10:
Problem-Specific Data (xₚ): The primary input is the post-fast-Fourier-transform (post-FFT) received time-frequency resource grid. Additionally, a resource grid containing only pilot symbols (with data locations set to zero) is included.
Desired Solution (x₀): While transmitted signals are a straightforward choice, in this example, using the Linear Minimum Mean Square Error (LMMSE) equalizer output under ideal conditions (perfect CSI) provides a more effective training target. This approach not only better captures the solution distribution but also offers improved soft information to the decoder, as reflected in the Bit Error Rate (BER) results.

During training, a new resource grid is generated at each iteration, sampling from the channel and AWGN distributions to create received signals. The training and sampling phases are implemented according to Algorithms 1 and 2.

To evaluate the DM-based framework, its performance is compared with two baseline methods: the LMMSE equalizer with perfect CSI (PCSI) and the LMMSE equalizer with least squares-based imperfect CSI (ICSI). Unlike these baselines, the DM-based framework requires no CSI information during training or sampling.

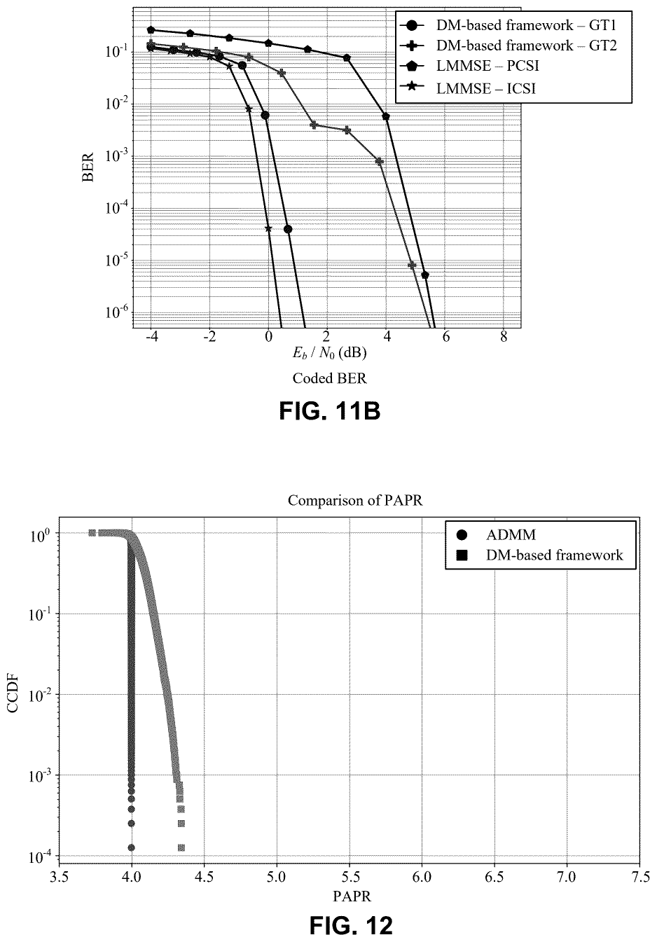

Uncoded and coded BER results are shown in FIGS. 11A and 11B, respectively, comparing the DM-based framework with two ground truth options: LMMSE output (GT1) and transmitted signals (GT2). The DM-based framework with GT1 performs within 0.5 decibel (dB) of PCSI over all SNR ranges, demonstrating its capability as an OFDM receiver. In contrast, the DM-based framework with GT2 exhibits weaker coded BER performance. Tests with 64-QAM and 256-QAM constellations confirm these findings, wherein the DM-based framework with GT1 stays within one (1) dB of PCSI at 10⁻² uncoded BER and 10⁻⁶ coded BER. While not shown, the gap between PCSI and ICSI increases with higher constellation sizes.

### Example 2

In some implementations, the DM-based framework disclosed herein may be used on the transmitter side for Peak-to-Average Power Ratio (PAPR) reduction. The parameters of the DM-based framework used in this example are shown in TABLE 1.

PAPR is an issue in OFDM systems, as it can impact the performance of power amplifiers and overall system efficiency. High PAPR values necessitate the use of power amplifiers operating at high back-off levels, leading to reduced power efficiency and increased cost. Therefore, effective PAPR reduction techniques are useful and/or helpful for the deployment of OFDM systems.

To address the PAPR reduction problem, the DM-based framework disclosed herein is used to generate pre-distorted OFDM signals with reduced PAPR. The following steps are involved:
Problem-Specific Data (xₚ): The initial frequency-domain OFDM signal is the sole input to the conditional encoder 444. This input provides the model with the fundamental structure of the OFDM signal, including its subcarrier allocation and modulation scheme.
Desired Solution (x₀): The pre-distorted time-domain and frequency-domain signals generated by the Alternating Direction Method of Multipliers (ADMM) algorithm (which is an algorithm that solves convex optimization problems by breaking them into smaller pieces) serve as the ground truth. These signals represent the desired output with reduced PAPR.

The DM-based framework is trained to learn the mapping between the initial OFDM signal (xₚ) and the desired pre-distorted signals (x₀). During training, the model is fed with pairs of (xₚ,x₀) in accordance with Algorithm 1. Once trained, the DM-based framework can generate new pre-distorted signals by using the original frequency domain (OFD) as the guidance signal and by starting from pure noise and iteratively denoising the signal in accordance with Algorithm 2. The conditional encoder 444 guides the denoising process, ensuring that the generated signals adhere to the underlying structure of the OFDM signal and exhibit similar PAPR reduction properties to those obtained from the ADMM algorithm.

FIG. 12 compares the PAPR distributions of the signals generated by the DM-based framework and ADMM, demonstrating the effectiveness of the DM-based framework disclosed herein.

The DM-based framework and method disclosed herein provide various benefits.

For example, by adapting DM with guidance mechanism in physical layer of communication systems such as wireless communication systems, the DM-based framework and method disclosed herein provide performance improvement over discriminative models in complex PHY problem sets.

By using the communication-aware conditional encoder 444 to act as a dedicated guidance mechanism, the DM-based framework and method disclosed herein enable the DM model to learn and generate more accurate solutions, make the approach applicable to a wider range of communication scenarios, and use relaxed signal assumptions.

By using a standard-DDPM-like sampling process, the DM-based framework and method disclosed herein avoid making approximations about the initial signal used in the reverse process (which may otherwise lead to sampling performance degradation).

As described above, the DM-based framework and method disclosed herein may be adapted to a wide range of PHY problems. Moreover, any of the three NNs 444, 446, and 450 involved in the NPNN 408 may be modified as needed or desired without departure from the general idea of the DM-based framework and method disclosed herein. For instance, one may use more or less convolutional layers in the conditional encoder 444 or replace the U-Net used in the main NN 450 with any other suitable NN.

TABLE 2 below lists some acronyms used in this disclosure.

TABLE 2
ACRONYMS

| | Acronym/ |
|---|---|
| | Abbreviation/ |
| Full Name | Initialism |
| Diffusion Models | DM |
| Denoising Diffusion Probabilistic Models | DDPM |
| Denoising Diffusion Implicit Models | DDIM |
| Physical Layer | PHY |
| Neural Network | NN |
| Base Station | BS |
| Low Density Parity Check | LDPC |
| Orthogonal Frequency Division Multiplexing | OFDM |
| Cyclic Prefix | CP |
| Peak to Average Power Ratio | PAPR |
| Channel State Information | CSI |
| Noise Prediction Neural Network | NPNN |
| Mean Squared Error | MSE |
| Linear Minimum Mean Squared Error | LMMSE |
| Additive White Gaussian Noise | AWGN |

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured (for example, by a TRP 102) before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various implementations of the DM-based framework and method are described. In various implementations, the methods disclosed herein may be implemented as hardware, software, firmware, or a combination thereof, and may be implemented in any suitable form. Depending on the functionalities of various features of the methods disclosed herein, some features may be implemented on the network side (such as in one or more TRPs), some other features may be implemented on the UE side, and/or yet some other features may be implemented on both the TRP and the UE sides. Depending on the functionalities of various features of the methods disclosed herein, some features may be implemented on the transmitting side (such as in one or more TRPs and/or one or more UEs for transmission), some other features may be implemented on the receiving side (such as in one or more TRPs and/or one or more UEs for receiving), and/or yet some other features may be implemented on both the transmitting and the receiving sides.

For example, in some implementations, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some implementations, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some implementations, an apparatus may not have any processors or computer-readable storage devices or media. Rather, the apparatus may comprise any other suitable physical or virtual (explained below) components for implementing the methods disclosed herein.

In some implementations, the computer-executable instructions that implement the methods disclosed herein may be one or more computer programs, one or more program products, or a combination thereof.

In some implementations, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various implementations, including not only method implementations, but also other implementations such as apparatus implementations and implementations related to non-transitory computer readable storage media. implementations may incorporate, individually or in combinations, the features disclosed herein.

Although this disclosure refers to illustrative implementations, this is not intended to be construed in a limiting sense. Various modifications and combinations of the illustrative implementations, as well as other implementations of the disclosure, will be apparent to persons skilled in the art upon reference to the description.

Features disclosed herein in the context of any particular implementations may also or instead be implemented in other implementations. Method implementations, for example, may also or instead be implemented in apparatus, system, and/or computer program product implementations. In addition, although implementations are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described implementations and/or features thereof may be customized, separated, and/or combined as needed or desired. Moreover, although implementations have been described above with reference to the accompanying drawings, those of skill in the art will appreciate that variations and modifications may be made without departing from the scope thereof as defined by the appended claims.

What is claimed is:

1. A method comprising:
passing a communication signal to a first artificial intelligence (AI) model to obtain a first signal;
obtaining a plurality of second signals in accordance with a normal distribution;
determining a denoised signal; and
outputting the denoised signal;
wherein said determining the denoised signal comprises: iteratively performing following actions for a plurality of time-steps:
passing a current time-step selected from the plurality of time-steps to a second AI model to obtain a third signal,
passing the first signal, a selected second signal selected in the current time-step from the plurality of second signals, and the third signal to a third AI model to obtain a predicted signal, and
updating the second signal based on the predicted signal.

2. The method of claim 1, wherein the first AI model comprises:
a sequence of convolutional layers; and
one or more pairs of functions, each pair of functions being between a neighboring pair of convolutional layers, and comprising a layer normalization (LN) function and a rectified linear unit (ReLU) activation function; and
wherein the third AI model comprises a U-Net model.

3. The method of claim 1, wherein the plurality of time-steps comprise an ordered sequence of S time-steps τ_{S}, τ_{S-1}, . . . , τ₁ with τ₁<τ₂< . . . <τ_{S};
wherein the second signal is updated as:
$${x}_{{τ}_{i - 1}} = \sqrt{{\overline{α}}_{{τ}_{i - 1}}} ( \frac{{x}_{{τ}_{i}} - \sqrt{1 - {\overline{α}}_{{τ}_{i}}} {ϵ}_{θ} ( {x}_{{τ}_{i}} , {x}_{p} , {τ}_{i} )}{\sqrt{{\overline{α}}_{{τ}_{i}}}} ) + \sqrt{1 - {\overline{α}}_{{τ}_{i - 1}} - {η}_{{τ}_{i}}^{2}} {ϵ}_{θ} ( {x}_{{τ}_{i}} , {x}_{p} , {τ}_{i} ) + {η}_{{τ}_{i}} ψ .$$
where τᵢ is the current time-step, τᵢ₋₁ is a next time-step, x_{τ}_{ᵢ} is the second signal in the current time-step τᵢ, x_{τ}_{_{i−1}} is the second signal in the next time-step τᵢ₋₁, xₚ is the communication signal, ∈₇₄ (x_{τ}_{ᵢ},xₚ,τᵢ) is the predicted signal,
$${\overline{α}}_{{τ}_{i}} = {\prod }_{k = 1}^{{τ}_{i}} {α}_{k} = {\prod }_{k = 1}^{{τ}_{i}} ( 1 - {β}_{k} ) , {β}_{k} ∈ ( 0 , 1 )$$
is a noise variance schedule at the time-step k, 0≤η_{τ}_{ᵢ}≤1 is a stochasticity parameter, and
where ψ is obtained in accordance with a normal distribution if the current time-step is not τ₁, or is zero if the current time-step is τ₁.

4. The method of claim 1 further comprising:
iteratively performing following actions for training the third AI model until predicted signal converges to a random signal:
obtaining a training time-step by sampling from a set of training time-steps of 1, 2, . . . , T in accordance with a uniform distribution,
obtaining a training input signal and a desired output signal from a training dataset,
obtaining the random signal based on a normal distribution,
passing the training input signal to the first AI model to obtain the first signal,
passing the training time-step to the second AI model to obtain the third signal,
calculating the second signal based on the random signal and the desired output signal,
passing the first signal, the second signal, and the third signal to the third AI model to obtain the predicted signal, and
updating the third AI model based on the random signal and the predicted signal.

5. The method of claim 4, wherein the set of time-steps comprise S time-steps and is a subset of the set of training time-steps of 1, 2, . . . , T, where S<<T.

6. The method of claim 4, wherein the second signal is calculated as:
$${x}_{t} = \sqrt{{\overline{α}}_{t}} {x}_{0} + \sqrt{1 - {\overline{α}}_{t}} ϵ ,$$
where t is the training time-step, xₜ is the second signal, x₀ is the desired output signal, ∈ is the random signal,
$${\overline{α}}_{t} = {\prod }_{k = 1}^{t} {α}_{k} = {\prod }_{k = 1}^{t} ( 1 - {β}_{k} ) ,$$
and βₖ∈(0,1) is a noise variance schedule at the time-step k; and
wherein said updating the third AI model based on the random signal and the predicted signal comprises:
updating the third AI model based on a gradient descent step obtained from:
$${∇}_{θ} [ {‖ {ϵ}_{θ} ( {x}_{t} , {x}_{p} , t ) - ϵ ‖}^{2} ] .$$

7. A module comprising:
one or more processors; and
one or more memories storing instructions; wherein the instructions, when executed, cause the module to perform the method of claim 1.

8. The module of claim 7, wherein the first AI model comprises:
a sequence of convolutional layers; and
one or more pairs of functions, each pair of functions being between a neighboring pair of convolutional layers, and comprising a layer normalization (LN) function and a rectified linear unit (ReLU) activation function; and
wherein the third AI model comprises a U-Net model.

9. The module of claim 7, wherein the plurality of time-steps comprise an ordered sequence of S time-steps τ_{S}, τ_{S-1}, . . . , τ₁ with τ₁<τ₂< . . . <τ_{S};
wherein the second signal is updated as:
$${x}_{{τ}_{i - 1}} = \sqrt{{\overline{α}}_{{τ}_{i - 1}}} ( \frac{{x}_{{τ}_{i}} - \sqrt{1 - {\overline{α}}_{{τ}_{i}}} {ϵ}_{θ} ( {x}_{{τ}_{i}} , {x}_{p} , {τ}_{i} )}{\sqrt{{\overline{α}}_{{τ}_{i}}}} ) + \sqrt{1 - {\overline{α}}_{{τ}_{i - 1}} - {η}_{{τ}_{i}}^{2}} {ϵ}_{θ} ( {x}_{{τ}_{i}} , {x}_{p} , {τ}_{i} ) + {η}_{{τ}_{i}} ψ .$$
where τᵢ is the current time-step, τᵢ₋₁ is a next time-step, x_{τ}_{ᵢ} is the second signal in the current time-step τᵢ, x_{τ}_{_{i−1}} is the second signal in the next time-step τᵢ₋₁, xₚ is the communication signal, ∈_{θ}(x_{τ}_{ᵢ},xₚ,τᵢ) is the predicted signal,
$${\overline{α}}_{{τ}_{i}} = {\prod }_{k = 1}^{{τ}_{i}} {α}_{k} = {\prod }_{k = 1}^{{τ}_{i}} ( 1 - {β}_{k} ) , {β}_{k} ∈ ( 0 , 1 )$$
is a noise variance schedule at the time-step k, 0≤η_{τ}_{ᵢ}≤1 is a stochasticity parameter, and
where ψ is obtained in accordance with a normal distribution if the current time-step is not τ₁, or is zero if the current time-step is τ₁.

10. The module of claim 7 further comprising:
iteratively performing following actions for training the third AI model until predicted signal converges to a random signal:
obtaining a training time-step by sampling from a set of training time-steps of 1, 2, . . . , T in accordance with a uniform distribution,
obtaining a training input signal and a desired output signal from a training dataset,
obtaining the random signal based on a normal distribution,
passing the training input signal to the first AI model to obtain the first signal,
passing the training time-step to the second AI model to obtain the third signal,
calculating the second signal based on the random signal and the desired output signal,
passing the first signal, the second signal, and the third signal to the third AI model to obtain the predicted signal, and
updating the third AI model based on the random signal and the predicted signal.

11. The module of claim 10, wherein the set of time-steps comprise S time-steps and is a subset of the set of training time-steps of 1, 2, . . . , T, where S<<T.

12. The module of claim 10, wherein the second signal is calculated as:
$${x}_{t} = \sqrt{{\overline{α}}_{t}} {x}_{0} + \sqrt{1 - {\overline{α}}_{t}} ϵ ,$$
where t is the training time-step, xₜ is the second signal, x₀ is the desired output signal, ∈ is the random signal,
$${\overline{α}}_{t} = {\prod }_{k = 1}^{t} {α}_{k} = {\prod }_{k = 1}^{t} ( 1 - {β}_{k} ) ,$$
and βₖ∈(0,1) is a noise variance schedule at the time-step k; and
wherein said updating the third AI model based on the random signal and the predicted signal comprises:
updating the third AI model based on a gradient descent step obtained from:
$${∇}_{θ} [ {‖ {ϵ}_{θ} ( {x}_{t} , {x}_{p} , t ) - ϵ ‖}^{2} ] .$$

13. One or more non-transitory, computer-readable storage media comprising computer-executable instructions, wherein the instructions, when executed, cause one or more processors to perform the method of claim 1.

14. The one or more non-transitory, computer-readable storage media of claim 13, wherein the first AI model comprises:
a sequence of convolutional layers; and
one or more pairs of functions, each pair of functions being between a neighboring pair of convolutional layers, and comprising a layer normalization (LN) function and a rectified linear unit (ReLU) activation function.

15. The one or more non-transitory, computer-readable storage media of claim 14, wherein each convolutional layer comprises a two-dimensional (2D) convolutional layer.

16. The one or more non-transitory, computer-readable storage media of claim 13, wherein the third AI model comprises a U-Net model.

17. The one or more non-transitory, computer-readable storage media of claim 13, wherein the plurality of time-steps comprise an ordered sequence of S time-steps τ_{S}, τ_{S-1}, . . . , τ₁ with τ₁<τ₂< . . . <τ_{S};
wherein the second signal is updated as:
$${x}_{{τ}_{i - 1}} = \sqrt{{\overline{α}}_{{τ}_{i - 1}}} ( \frac{{x}_{{τ}_{i}} - \sqrt{1 - {\overline{α}}_{{τ}_{i}}} {ϵ}_{θ} ( {x}_{{τ}_{i}} , {x}_{p} , {τ}_{i} )}{\sqrt{{\overline{α}}_{{τ}_{i}}}} ) + \sqrt{1 - {\overline{α}}_{{τ}_{i - 1}} - {η}_{{τ}_{i}}^{2}} {ϵ}_{θ} ( {x}_{{τ}_{i}} , {x}_{p} , {τ}_{i} ) + {η}_{{τ}_{i}} ψ .$$
where τᵢ is the current time-step, τᵢ₋₁ is a next time-step, x_{τ}_{ᵢ} is the second signal in the current time-step τᵢ, x_{τ}_{_{i−1}} is the second signal in the next time-step τᵢ₋₁, xₚ is the communication signal, ∈_{θ}(x_{τ}_{ᵢ},xₚ,τᵢ) is the predicted signal,
$${\overline{α}}_{{τ}_{i}} = {\prod }_{k = 1}^{{τ}_{i}} {α}_{k} = {\prod }_{k = 1}^{{τ}_{i}} ( 1 - {β}_{k} ) , {β}_{k} ∈ ( 0 , 1 )$$
is a noise variance schedule at the time-step k, 0≤η_{τ}_{ᵢ}≤1 is a stochasticity parameter, and
where ψ is obtained in accordance with a normal distribution if the current time-step is not τ₁, or is zero if the current time-step is τ₁.

18. The one or more non-transitory, computer-readable storage media of claim 13 further comprising:
iteratively performing following actions for training the third AI model until predicted signal converges to a random signal:
obtaining a training time-step by sampling from a set of training time-steps of 1, 2, . . . , T in accordance with a uniform distribution,
obtaining a training input signal and a desired output signal from a training dataset,
obtaining the random signal based on a normal distribution,
passing the training input signal to the first AI model to obtain the first signal,
passing the training time-step to the second AI model to obtain the third signal,
calculating the second signal based on the random signal and the desired output signal,
passing the first signal, the second signal, and the third signal to the third AI model to obtain the predicted signal, and
updating the third AI model based on the random signal and the predicted signal.

19. The one or more non-transitory, computer-readable storage media of claim 18, wherein the set of time-steps comprise S time-steps and is a subset of the set of training time-steps of 1, 2, . . . , T, where S<<T.

20. The one or more non-transitory, computer-readable storage media of claim 18, wherein the second signal is calculated as:
$${x}_{t} = \sqrt{{\overline{α}}_{t}} {x}_{0} + \sqrt{1 - {\overline{α}}_{t}} ϵ ,$$
where t is the training time-step, xₜ is the second signal, x₀ is the desired output signal, ∈ is the random signal,
$${\overline{α}}_{t} = {\prod }_{k = 1}^{t} {α}_{k} = {\prod }_{k = 1}^{t} ( 1 - {β}_{k} ) ,$$
and βₖ∈(0,1) is a noise variance schedule at the time-step k; and
wherein said updating the third AI model based on the random signal and the predicted signal comprises:
updating the third AI model based on a gradient descent step obtained from:
$${∇}_{θ} [ {‖ {ϵ}_{θ} ( {x}_{t} , {x}_{p} , t ) - ϵ ‖}^{2} ] .$$
